(19) United States
(12) Patent Application Publication
(10) Pub. No.: US 2026/0096691 A1
(43) Pub. Date: Apr. 9, 2026

(54) COFFEE GRINDER

(71) Applicant: Eduard BIERNATEK, Rodgau (DE)

(72) Inventor: Eduard BIERNATEK, Rodgau (DE)

(21) Appl. No.: 19/114,008

(22) PCT Filed: Sep. 18, 2023
(86) PCT No.: PCT/EP2023/075642

§ 371 Date: Jun. 25, 2025

(30) Foreign Application Priority Data
Sep. 23, 2022 (LU) LU502831
Sep. 23, 2022 (LU) LU502832

(51) Int. Cl. A47J 42/04; A47J 42/06; A47J 42/46

(52) U.S. Cl. CPC A47J 42/04; A47J 42/06; A47J 42/46

(57) ABSTRACT

The invention relates to a coffee grinder having a grinding mechanism and having a housing, which acts as a holder for at least one bearing bracket, by means of which the at least one grinder element is mounted rotatably relative to the housing, and which has a filling opening for coffee beans to be ground. The coffee grinder is distinguished by the fact that the housing is manufactured from titanium or a titanium alloy.

### CROSS-REFERENCE TO RELATED APPLICATIONS

The present application is the U.S. national phase of international application no. PCT/EP2023/075642 filed Sep. 18, 2023 which claims priority to and benefit of Luxembourgian Patent Application Nos. 502831 and 502832 filed Sep. 23, 2022, the entire disclosures of which are incorporated herein by reference.

### FIELD

The disclosure relates to a coffee grinder having a grinding mechanism and having a housing, which acts as a holder for at least one bearing bracket, by means of which the at least one grinder element is mounted rotatably relative to the housing, and which has a filling opening for coffee beans to be ground.

### BACKGROUND

Previously, coffee grinders of the type stated at the outset were often produced from wood. More modern designs, in particular manually operated precision coffee grinders, generally have a housing made of aluminum or of stainless steel. However, it has now been found that the taste of the coffee may be affected if the coffee beans and/or the ground coffee powder come into contact with the material of the coffee grinder.

### SUMMARY

It is therefore the object of the present disclosure to specify a coffee grinder which can be designed to be compact and, at the same time, such that the rotatably mounted components remain precisely aligned during a grinding process and any effect on the taste of the coffee is avoided.

The object is achieved by a coffee grinder of the type stated at the outset which is distinguished by the fact that the housing is manufactured from titanium or a titanium alloy.

The coffee grinder according to the disclosure has the very particular advantage that both precise and load-resistant holding of the bearing components is made possible and, in addition, that the taste of the coffee is not negatively affected.

According to the disclosure, as already mentioned, it has been recognized that the taste of the coffee may be affected if the coffee beans and/or the ground coffee powder come into contact with the material of the coffee grinder. This affects coffee grinders made from the usual materials, especially those made of aluminum, this being attributable to the oils and acids contained in the coffee, which react with the aluminum. It has been found that even coffee grinders made of stainless steel negatively affect the taste of the coffee (although to a lesser extent than, for example, aluminum) since the oils and acids contained in the coffee also react with stainless steel. According to the disclosure, it has been recognized, in particular, that this effect is intensified particularly by the fact that the coffee beans to be ground are in motion relative to the housing during the grinding process and therefore rub along the housing, thereby causing damage in the passivation layer.

Proceeding from this starting point, it would be possible to try and reduce the areas which come into contact with the coffee beans to be ground and the ground coffee and/or to shield them by means of special coatings, e.g. made of ceramics. However, this is disadvantageously not only very expensive but inevitably leads to complex designs, which either have a large volume or are susceptible to twisting and deformation, or both. These designs have the very particular disadvantage that they either can no longer be held and operated ergonomically or are deformed during the grinding process (even if only slightly), with the result that, in particular, the rotatably mounted components are no longer held precisely in position relative to the other components. This inevitably leads to the relevant parts of the grinding mechanism not being held in their desired position relative to one another, leading ultimately to an unsatisfactory grinding result. For example, it may happen that a grinding rotor of these coffee grinders is displaced radially relative to a grinding stator during the grinding process, during which considerable forces and moments are exerted, e.g. via a hand crank, with the result that the radial clearance of the grinding rotor with respect to the grinding stator is larger on one side of the grinding rotor and smaller on the opposite side of the grinding rotor. The result is that ultimately the coffee powder does not have a uniform grain size. However, a uniform grain size of the coffee powder is absolutely essential for the preparation of a premium coffee.

It has surprisingly been found that titanium has the property of not affecting the taste of the coffee, and that furthermore titanium is sufficiently stable to achieve a compact coffee grinder which is sufficiently resistant to twisting and deformation under loads that occur during the grinding process. In the context of this application, the term “titanium alloy” is understood, in particular, to mean a macroscopically homogeneous material, the main component of which (preferably more than 90 percent by mass, in particular more than 95 percent by mass) is titanium.

The housing can advantageously be of tubular design. Such a design has the particular advantage that it is particularly compact and stable. In this case, the filling opening can be formed by an upper tube opening, for example.

In a very particularly advantageous embodiment, the housing has a filling opening designed as a filling funnel.

The housing preferably has a discharge opening for the coffee powder. The discharge opening can be formed, for example, by a lower tube opening if the housing is of tubular design.

In a very particularly advantageous embodiment, the housing surrounds a receiving space for coffee beans to be ground. Such an embodiment has the very particular advantage that a supply of coffee beans to be ground can be introduced and, if necessary, can even remain for a prolonged period in the receiving space without the risk of affecting the taste since, as explained in detail above, the coffee beans can come into contact with the inner wall of the housing in a manner that does not cause damage. Moreover, such an embodiment has the very particular advantage that essentially no additional components are required to form the receiving space.

An embodiment in which the housing has a circular outer contour and/or a circular inner contour in a cross-sectional plane perpendicular to its direction of longitudinal extent is very particularly ergonomic and particularly stable. In particular, the housing of such an embodiment is particularly easy to handle because it can be gripped ergonomically with one hand, especially if the outside diameter is in a range of from 30 mm to 120 mm, very particularly in a range of from 35 mm to 70 mm or from 50 mm to 70 mm.

In a very particularly stable embodiment which manages with a small number of components, the housing is manufactured integrally from a single piece of raw material. In particular, such a housing can be produced from a cylindrical piece of raw material, in particular by turning and/or milling.

In another embodiment, which is very particularly stable and yet can be of very flexible design, the housing is of multipart design, wherein at least the part of the housing on which the at least one bearing bracket is directly arranged is manufactured integrally from a single piece of raw material, in particular from a tube.

In a special embodiment, the at least one bearing bracket is secured on the inner side of the housing. In particular, provision may advantageously be made for the at least one bearing bracket to be secured on the inner side of the housing by frictional engagement and/or form-locking engagement. In a very particularly advantageous embodiment, the at least one bearing bracket is secured on the inner side of the housing exclusively by frictional engagement. Such an embodiment has the very particular advantage that the bearing bracket or bearing brackets can be fitted easily, preferably without tools, and removed again when required (e.g. for a cleaning or maintenance process). An embodiment in which the at least one bearing bracket has at least one contact portion, which is shaped oppositely in complementary fashion to the portion of the housing against which it rests, is particularly stable and precise. In this way, high precision is achieved, especially for purely frictional retention of the bearing bracket.

In particular, the coffee grinder according to the disclosure can also be designed in such a way that the at least one bearing bracket is secured without a materially bonded connection on the inner side of the housing. In this way, complex welding or adhesive bonding processes are advantageously avoided. Welding processes, in particular, are disadvantageous because the components of the coffee grinder may be accidentally distorted during welding by the effect of temperature, and the required precision of the coffee grinder can therefore ultimately no longer be achieved.

In a very particularly advantageous embodiment, the at least one bearing bracket is clamped between different portions of the inner side of the housing. For this purpose, the inner side of the housing can advantageously be of conical design.

For example, the bearing bracket can be designed as a bar which, in respect of its direction of longitudinal extent, is arranged perpendicularly to the direction of longitudinal extent of the, in particular, tubular housing and is clamped in the interior of the housing. In this case, provision can advantageously be made for each of the ends of the bar-shaped bearing bracket to have a contact portion, which is shaped oppositely in complementary fashion to the portion of the housing against which it rests. However, other embodiments in which the bearing bracket is designed as a bar are also possible.

Very generally, the coffee grinder according to the disclosure can be designed in such a way that the at least one bearing bracket can be mounted without tools in the housing and/or can be released without tools from the housing. Such an embodiment is not only particularly advantageous in respect of production but also in respect of subsequent cleaning and maintenance processes.

The at least one bearing bracket can be arranged in the receiving space for the coffee beans to be ground. In this case, it is advantageous for the at least one bearing bracket also to be manufactured from titanium or a titanium alloy in order to avoid affecting the taste of the coffee through contact with the bearing bracket. Moreover, such an embodiment is particularly advantageous if the bearing bracket is secured directly in the housing, in particular by means of at least one clamping connection. In such an embodiment, the bearing bracket has the same material properties, in particular the same coefficient of expansion, as the housing, thus avoiding or at least reducing the risk of accidental release of the connection.

The coffee grinder according to the disclosure preferably has a plurality of bearing brackets. In particular, the coffee grinder can have precisely two bearing brackets, in order, for example, to support a shaft, in particular a drive shaft, reliably and precisely in a rotatable manner.

The bearing bracket can advantageously have a bearing in order to rotatably support the grinder element, e.g. a drive shaft. The bearing is preferably a rolling bearing, in particular a ball bearing or a needle bearing. Alternatively, the bearing may also be designed as a sliding bearing.

Very generally, provision can advantageously be made for at least the inner side of the housing to have a surface structure produced by grinding and/or polishing. For example, the housing may first of all have been produced by turning and then machined further by a grinding process. The grinding process can be followed by a polishing process.

As already mentioned, the grinder element can be a shaft, e.g. a drive shaft connected or connectable to a hand crank. The shaft too can advantageously be manufactured from titanium or a titanium alloy, especially if the shaft is arranged in such a way that it comes into contact with the coffee beans and/or the coffee powder. Making the shaft from titanium or a titanium alloy is recommended especially if the shaft passes through the receiving space.

In a special embodiment, the shaft is connected for conjoint rotation to a driving device, on the one hand, and is connected for conjoint rotation to a grinding rotor, in particular to a grinding cone, of the grinding mechanism, on the other hand. The driving device may be a hand crank, for example.

Very generally, the coffee grinder can be designed as a manually driven coffee grinder. An embodiment in which the housing is designed to be held in one hand of a user during a grinding process, wherein the user can operate the hand crank with their other hand, is of very particular advantage.

Alternatively, the coffee grinder can be designed as an electrically driven coffee grinder. In particular, provision can advantageously be made for the driving device to have an electric drive motor.

According to an independent concept of the disclosure, a spice grinder, in particular for grinding peppercorns or salt grains, having a grinding mechanism (1) and having a housing (4), which acts as a holder for at least one bearing bracket (5), by means of which at least one grinder element is mounted rotatably relative to the housing (4), and which has a filling opening (13) for spices to be ground, wherein the housing (4) is manufactured from titanium or a titanium alloy, is particularly advantageous. The spice grinder can advantageously have one or more of the following aspects mentioned:
1. A spice grinder, in particular for grinding peppercorns or salt grains, having a grinding mechanism (1) and having a housing (4), which acts as a holder for at least one bearing bracket (5), by means of which at least one grinder element is mounted rotatably relative to the housing (4), and which has a filling opening (13) for spices to be ground, wherein the housing (4) is manufactured from titanium or a titanium alloy.
2. The spice grinder according to aspect 1, wherein the housing (4) is of tubular design.
3. The spice grinder according to aspect 2, wherein the filling opening (7) is formed by an upper tube opening.
4. The spice grinder according to one of aspects 1 to 3, wherein the housing (4) has a discharge opening (13) for the ground spice.
5. The spice grinder according to aspects 2 and 4, wherein the discharge opening (13) is formed by a lower tube opening.
6. The spice grinder according to one of aspects 1 to 5, wherein the housing (4) surrounds a receiving space for a spice to be ground, in particular peppercorns or salt grains.
7. The spice grinder according to one of aspects 1 to 6, wherein the housing (4) has a circular outer contour and/or a circular inner contour in a cross-sectional plane perpendicular to its direction of longitudinal extent.
8. The spice grinder according to one of aspects 1 to 7, wherein the housing (4) is manufactured integrally from a single piece of raw material, in particular from a tube.
9. The spice grinder according to one of aspects 1 to 7, wherein the housing (4) is of multipart design, wherein at least the part of the housing (4) on which the at least one bearing bracket (5) is directly arranged is manufactured integrally from a single piece of raw material, in particular from a tube.
10. The spice grinder according to one of aspects 1 to 9, wherein the at least one bearing bracket (5) is secured on the inner side of the housing (4).
11. The spice grinder according to aspect 10, wherein the at least one bearing bracket (5) is secured on the inner side of the housing (4) by frictional engagement and/or form-locking engagement.
12. The spice grinder according to one of aspects 1 to 11, wherein the at least one bearing bracket (5) is secured without a materially bonded connection on the inner side of the housing (4).
13. The spice grinder according to one of aspects 1 to 12, wherein the at least one bearing bracket (5) is clamped between different portions of the inner side of the housing (4).
14. The spice grinder according to one of aspects 1 to 13, wherein the at least one bearing bracket (5) has at least one contact portion, which is shaped oppositely in complementary fashion to the portion of the housing (4) against which it rests.
15. The spice grinder according to one of aspects 1 to 14, wherein the bearing bracket (5) is designed as a bar.
16. The spice grinder according to aspect 14 and 15, wherein the ends of the bar are shaped oppositely in complementary fashion to the portions of the housing (4) against which they rest.
17. The spice grinder according to one of aspects 1 to 16, wherein at least one bearing bracket (5) is arranged in the receiving space (16) for spice to be ground.
18. The spice grinder according to one of aspects 1 to 17, wherein the at least one bearing bracket (5) can be mounted without tools in the housing (4) and/or can be released without tools from the housing (4).
19. The spice grinder according to one of aspects 1 to 18, wherein the at least one bearing bracket (5) is manufactured from titanium or a titanium alloy.
20. The spice grinder according to one of aspects 1 to 19, wherein the spice grinder has precisely two, in particular identical, bearing brackets (5).
21. The spice grinder according to one of aspects 1 to 20, wherein each bearing bracket (5) has a bearing, in particular a rolling bearing (8).
22. The spice grinder according to one of aspects 1 to 21, wherein at least the inner side of the housing (4) has a surface structure produced by grinding and/or polishing.
23. The spice grinder according to one of aspects 1 to 22, wherein the grinder element is a shaft (6).
24. The spice grinder according to aspect 23, wherein the grinder element is manufactured from titanium or a titanium alloy.
25. The spice grinder according to aspect 23 or 24, wherein the shaft (6) is connected for conjoint rotation to a driving device, on the one hand, and is connected for conjoint rotation to a grinding rotor (2), in particular to a grinding cone, of the grinding mechanism (1), on the other hand.
26. The spice grinder according to aspect 25, wherein the driving device is designed as a hand crank (15).
27. The spice grinder according to one of aspects 1 to 26, wherein the spice grinder is manually driven.
28. The spice grinder according to aspect 26 or 27, wherein the housing (4) is designed to be held in one hand of a user during a grinding process, wherein the user can operate the hand crank (15) with their other hand.
29. The spice grinder according to aspect 25, wherein the driving device is an electric drive motor.

In respect of the spice grinder, the following applies:

Previously, spice grinders were often produced from wood. More modern designs generally have a housing made of aluminum or of stainless steel. However, it has now been found that the taste of the ground spices may be affected if the spices to be ground and/or the ground spices come into contact with the material of the spice grinder.

It is therefore another object of the present disclosure to specify a spice grinder which can be designed to be compact and, at the same time, such that the rotatably mounted components remain precisely aligned during a grinding process and any effect on the taste of the spices is avoided.

The object is achieved by a spice grinder which is distinguished by the fact that the housing is manufactured from titanium or a titanium alloy.

The spice grinder according to the disclosure has the very particular advantage that both precise and load-resistant holding of the bearing components is made possible and, in addition, that the taste of the spices is not negatively affected.

According to the disclosure, as already mentioned, it has been recognized that the taste of the spices may be affected if the spices and/or the ground spice powder come into contact with the material of the spice grinder. This affects spice grinders made from the usual materials, especially those made of aluminum, this being attributable, in the case of pepper for example, to the oils and acids contained in the pepper, which react with the aluminum. It has been found that even spice grinders made of stainless steel negatively affect the taste of the spices since the oils and acids contained in the pepper, for example, also react with stainless steel. According to the disclosure, it has been recognized, in particular, that the taste of salt is also negatively affected because the salt grains to be ground are in motion relative to the housing during the grinding process and therefore rub along the housing, as a result of which parts of the passivation layer are scraped off. These parts of the passivation layer which negatively affect the taste ultimately get into the food to be spiced. In the case of other spices too, such as pepper, damage to the passivation layer also plays a role inasmuch as the already mentioned oils and acids encounter particularly sensitive points of attack at the damaged locations.

Proceeding from this as a starting point, it would be possible to try and reduce the areas which come into contact with the spices to be ground and the ground spice powder and/or to shield them by means of special coatings, e.g. made of ceramics. However, this is disadvantageously not only very expensive but inevitably leads to complex designs, which either have a large volume or are susceptible to twisting and deformation, or both. These designs have the very particular disadvantage that they either can no longer be held and operated ergonomically or are deformed during the grinding process (even if only slightly), with the result that, in particular, the rotatably mounted components are no longer held precisely in position relative to the other components. This inevitably leads to the relevant parts of the grinding mechanism not being held in their desired position relative to one another, leading ultimately to an unsatisfactory grinding result. For example, it may happen that a grinding rotor of these spice grinders is displaced radially relative to a grinding stator during the grinding process, during which considerable forces and moments are exerted, e.g. via a hand crank, with the result that the radial clearance of the grinding rotor with respect to the grinding stator is larger on one side of the grinding rotor and smaller on the opposite side of the grinding rotor. The result is that ultimately the spice powder does not have a uniform grain size. However, a uniform grain size of the ground spice is often decisive for the taste since spice particles of different sizes, in particular salt grains of different sizes, act on different taste receptors in humans.

It has surprisingly been found that titanium has the property of not affecting the taste of the spices, and that furthermore titanium is sufficiently stable to achieve a compact spice grinder which is sufficiently resistant to twisting and deformation under loads that occur during the grinding process. In the context of this application, the term “titanium alloy” is understood, in particular, to mean a macroscopically homogeneous material, the main component of which (preferably more than 90 percent by mass, in particular more than 95 percent by mass) is titanium.

In particular, the spice grinder can be designed to grind peppercorns, poppyseed or grains of table salt.

The housing can advantageously be of tubular design. Such a design has the particular advantage that it is particularly compact and stable. In this case, the filling opening can be formed by an upper tube opening, for example.

In a very particularly advantageous embodiment, the housing has a filling opening designed as a filling funnel.

The housing preferably has a discharge opening for the ground spice. The discharge opening can be formed, for example, by a lower tube opening if the housing is of tubular design.

In a very particularly advantageous embodiment, the housing surrounds a receiving space for spices to be ground, e.g. peppercorns or salt grains. Such an embodiment has the very particular advantage that a supply of spices to be ground can be introduced and, if necessary, can even remain for a prolonged period in the receiving space without the risk of affecting the taste since, as explained in detail above, the spices can come into contact with the inner wall of the housing in a manner that does not cause damage. Moreover, such an embodiment has the very particular advantage that essentially no additional components are required to form the receiving space.

An embodiment in which the housing has a circular outer contour and/or a circular inner contour in a cross-sectional plane perpendicular to its direction of longitudinal extent is very particularly ergonomic and particularly stable. In particular, the housing of such an embodiment is particularly easy to handle because it can be gripped ergonomically with one hand, especially if the outside diameter is in a range of from 30 mm to 120 mm, very particularly in a range of from 35 mm to 70 mm or from 50 mm to 70 mm.

In a very particularly stable embodiment which manages with a small number of components, the housing is manufactured integrally from a single piece of raw material. In particular, such a housing can be produced from a cylindrical piece of raw material, in particular by turning and/or milling.

In another embodiment, which is very particularly stable and yet can be of very flexible design, the housing is of multipart design, wherein at least the part of the housing on which the at least one bearing bracket is directly arranged is manufactured integrally from a single piece of raw material, in particular from a tube.

In a special embodiment, the at least one bearing bracket is secured on the inner side of the housing. In particular, provision may advantageously be made for the at least one bearing bracket to be secured on the inner side of the housing by frictional engagement and/or form-locking engagement. In a very particularly advantageous embodiment, the at least one bearing bracket is secured on the inner side of the housing exclusively by frictional engagement. Such an embodiment has the very particular advantage that the bearing bracket or bearing brackets can be fitted easily, preferably without tools, and removed again when required (e.g. for a cleaning or maintenance process). An embodiment in which the at least one bearing bracket has at least one contact portion, which is shaped oppositely in complementary fashion to the portion of the housing against which it rests is particularly stable and precise. In this way, high precision is achieved, especially for purely frictional retention of the bearing bracket.

In particular, the spice grinder according to the disclosure can also be designed in such a way that the at least one bearing bracket is secured without a materially bonded connection on the inner side of the housing. In this way, complex welding or adhesive bonding processes are advantageously avoided. Welding processes, in particular, are disadvantageous because the components of the spice grinder may be accidentally distorted during welding by the effect of temperature, and the required precision of the spice grinder can therefore ultimately no longer be achieved.

In a very particularly advantageous embodiment, the at least one bearing bracket is clamped between different portions of the inner side of the housing. For this purpose, the inner side of the housing can advantageously be of conical design.

For example, the bearing bracket can be designed as a bar which, in respect of its direction of longitudinal extent, is arranged perpendicularly to the direction of longitudinal extent of the, in particular, tubular housing and is clamped in the interior of the housing. In this case, provision can advantageously be made for each of the ends of the bar-shaped bearing bracket to have a contact portion, which is shaped oppositely in complementary fashion to the portion of the housing against which it rests. However, other embodiments in which the bearing bracket is designed as a bar are also possible.

Very generally, the spice grinder according to the disclosure can be designed in such a way that the at least one bearing bracket can be mounted without tools in the housing and/or can be released without tools from the housing. Such an embodiment is not only particularly advantageous in respect of production but also in respect of subsequent cleaning and maintenance processes.

The at least one bearing bracket can be arranged in the receiving space for the spices to be ground, in particular peppercorns or salt grains. In this case, it is advantageous for the at least one bearing bracket also to be manufactured from titanium or a titanium alloy in order to avoid affecting the taste of the spice through contact with the bearing bracket. Moreover, such an embodiment is particularly advantageous if the bearing bracket is secured directly in the housing, in particular by means of at least one clamping connection. In such an embodiment, the bearing bracket has the same material properties, in particular the same coefficient of expansion, as the housing, thus avoiding or at least reducing the risk of accidental release of the connection.

The spice grinder according to the disclosure preferably has a plurality of bearing brackets. In particular, the spice grinder can have precisely two bearing brackets, in order, for example, to support a shaft, in particular a drive shaft, reliably and precisely in a rotatable manner.

The bearing bracket can advantageously have a bearing in order to rotatably support the grinder element, e.g. a drive shaft. The bearing is preferably a rolling bearing, in particular a ball bearing or a needle bearing. Alternatively, the bearing may also be designed as a sliding bearing.

Very generally, provision can advantageously be made for at least the inner side of the housing to have a surface structure produced by grinding and/or polishing. For example, the housing may first of all have been produced by turning and then machined further by a grinding process. The grinding process can be followed by a polishing process.

As already mentioned, the grinder element can be a shaft, e.g. a drive shaft connected or connectable to a hand crank. The shaft too can advantageously be manufactured from titanium or a titanium alloy, especially if the shaft is arranged in such a way that it comes into contact with the spices to be ground and/or the ground spice. Making the shaft from titanium or a titanium alloy is recommended especially if the shaft passes through the receiving space.

In a special embodiment, the shaft is connected for conjoint rotation to a driving device, on the one hand, and is connected for conjoint rotation to a grinding rotor, in particular to a grinding cone, of the grinding mechanism, on the other hand. The driving device may be a hand crank, for example.

Very generally, the spice grinder can be designed as a manually driven spice grinder. An embodiment in which the housing is designed to be held in one hand of a user during a grinding process, wherein the user can operate the hand crank with their other hand, is of very particular advantage.

Alternatively, the spice grinder can be designed as an electrically driven spice grinder. In particular, provision can advantageously be made for the driving device to have an electric drive motor.

### BRIEF DESCRIPTION OF THE DRAWING VIEWS

The subject matter of the disclosure is illustrated by way of example and schematically in the drawing and is described below with reference to the figures, wherein elements that are the same or have the same effect are provided with the same reference signs. In the drawing:

FIG. 1 shows a first exemplary embodiment of a coffee grinder according to the disclosure,

FIG. 2 shows a second exemplary embodiment of a coffee grinder according to the disclosure,

FIG. 3 shows a first exemplary embodiment of a spice grinder according to an independent inventive concept, and

FIG. 4 shows a second exemplary embodiment of a spice grinder according to an independent inventive concept.

### DETAILED DESCRIPTION

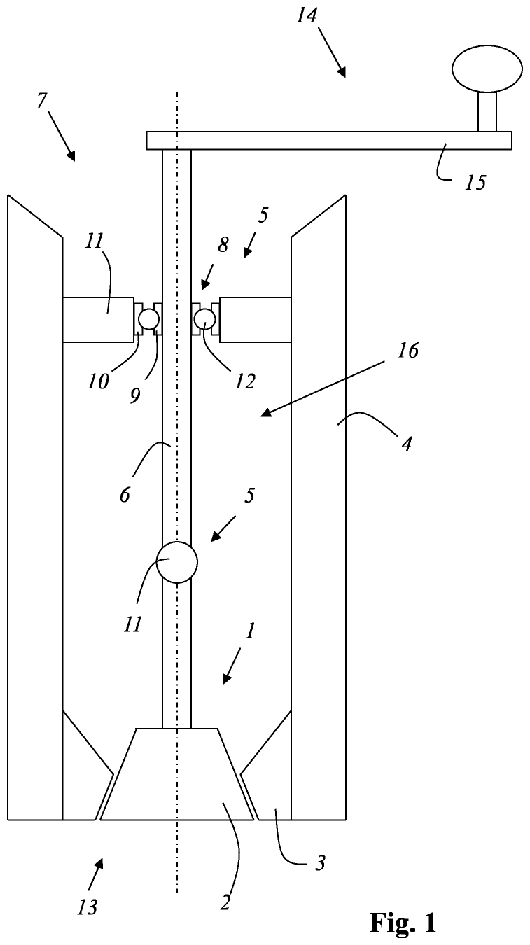

FIG. 1 shows a first exemplary embodiment of a coffee grinder according to the disclosure, having a grinding mechanism 1, which has a grinding rotor 2, namely a grinding cone, and a grinding stator 3, namely a grinding ring. The coffee grinder furthermore has a tubular housing 4, which acts as a holder for two bearing brackets 5, by means of which a grinder element, namely a shaft 6, is mounted so as to be rotatable relative to the housing 4.

The shaft 6 is connected for conjoint rotation to a driving device 14, namely a hand crank 15, on the one hand, and is connected for conjoint rotation to the grinding rotor 2 of the grinding mechanism 1, on the other hand.

The housing 4 has a filling opening 7 for coffee beans to be ground (not illustrated) and is preferably produced from a single piece of raw material, consisting of titanium or a titanium alloy. The housing 4 furthermore has a discharge opening 13 for the coffee powder (not illustrated). The housing 4 surrounds a receiving space 16 for the coffee beans to be ground. The bearing brackets 5 are arranged in the receiving space 16.

The bearing brackets 5, which are of substantially bar-shaped design, are arranged offset with respect to the direction of longitudinal extent of the housing (axial direction) and in such a way as to be rotated by 90° relative to one another. While the upper bearing bracket 5 extends in the plane of the drawing, the lower bearing bracket 5 extends perpendicularly to the plane of the drawing.

Each of the bearing brackets 5 has a rolling bearing 8. The rolling bearing 8 is in each case inserted into a bore in a holding bar 11. To this extent, the outer ring 10 of the rolling bearing 8 is in direct contact with the holding bar 11. The inner ring 9 of the rolling bearing 8 is in direct contact with the shaft 6. Rolling elements 12 are arranged between the inner ring 9 and the outer ring 10.

Each bearing bracket 5 is clamped between different portions of the inner side of the housing 4. However, the bearing brackets 5 could also be secured directly or indirectly on the housing 4 in some other way.

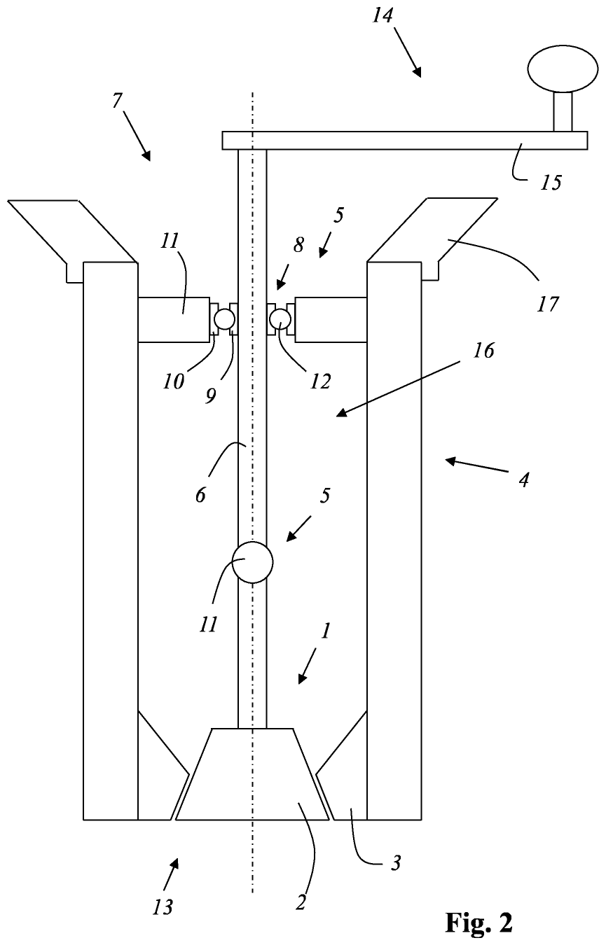

FIG. 2 shows a second exemplary embodiment of a coffee grinder according to the disclosure, the housing 4 of which, in contrast to the first exemplary embodiment, has an attachment that is manufactured separately, preferably from titanium or a titanium alloy, which acts as a filling funnel 17. It is also possible to produce the filling funnel 17 integrally from a single piece of raw material together with at least one other housing component, in particular together with a tubular housing portion.

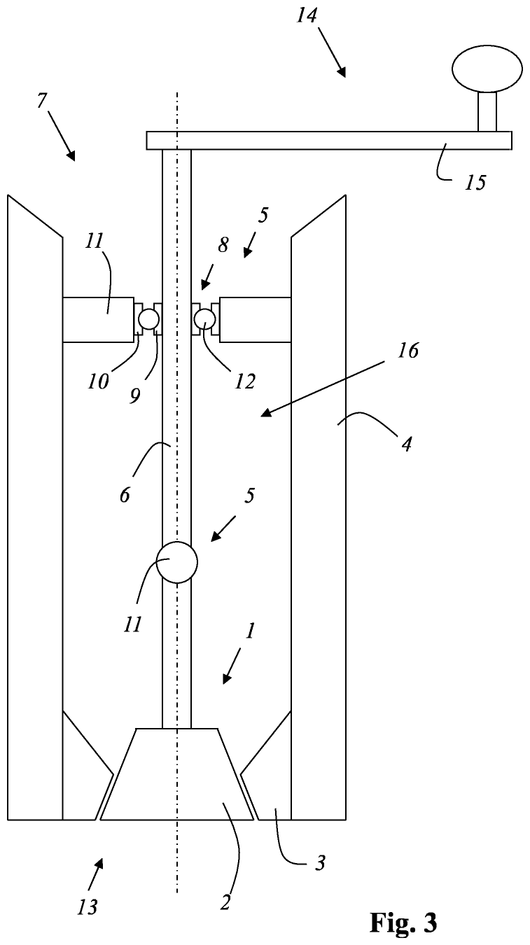

FIG. 3 shows a first exemplary embodiment of a spice grinder according to the disclosure in accordance with an independent inventive concept, having a grinding mechanism 1, which has a grinding rotor 2, namely a grinding cone, and a grinding stator 3, namely a grinding ring. The spice grinder furthermore has a tubular housing 4, which acts as a holder for two bearing brackets 5, by means of which a grinder element, namely a shaft 6, is mounted so as to be rotatable relative to the housing 4.

The shaft 6 is connected for conjoint rotation to a driving device 14, namely a hand crank 15, on the one hand, and is connected for conjoint rotation to the grinding rotor 2 of the grinding mechanism 1, on the other hand.

The housing 4 has a filling opening 7 for spices to be ground (not illustrated) and is preferably produced from a single piece of raw material, consisting of titanium or a titanium alloy. The housing 4 furthermore has a discharge opening 13 for the ground spice (not illustrated). The housing 4 surrounds a receiving space 16 for the spice to be ground. The bearing brackets 5 are arranged in the receiving space 16.

The bearing brackets 5, which are of substantially bar-shaped design, are arranged offset with respect to the direction of longitudinal extent of the housing (axial direction) and in such a way as to be rotated by 90° relative to one another. While the upper bearing bracket 5 extends in the plane of the drawing, the lower bearing bracket 5 extends perpendicularly to the plane of the drawing.

Each of the bearing brackets 5 has a rolling bearing 8. The rolling bearing 8 is in each case inserted into a bore in a holding bar 11. To this extent, the outer ring 10 of the rolling bearing 8 is in direct contact with the holding bar 11. The inner ring 9 of the rolling bearing 8 is in direct contact with the shaft 6. Rolling elements 12 are arranged between the inner ring 9 and the outer ring 10.

Each bearing bracket 5 is clamped between different portions of the inner side of the housing 4. However, the bearing brackets 5 could also be secured directly or indirectly on the housing 4 in some other way.

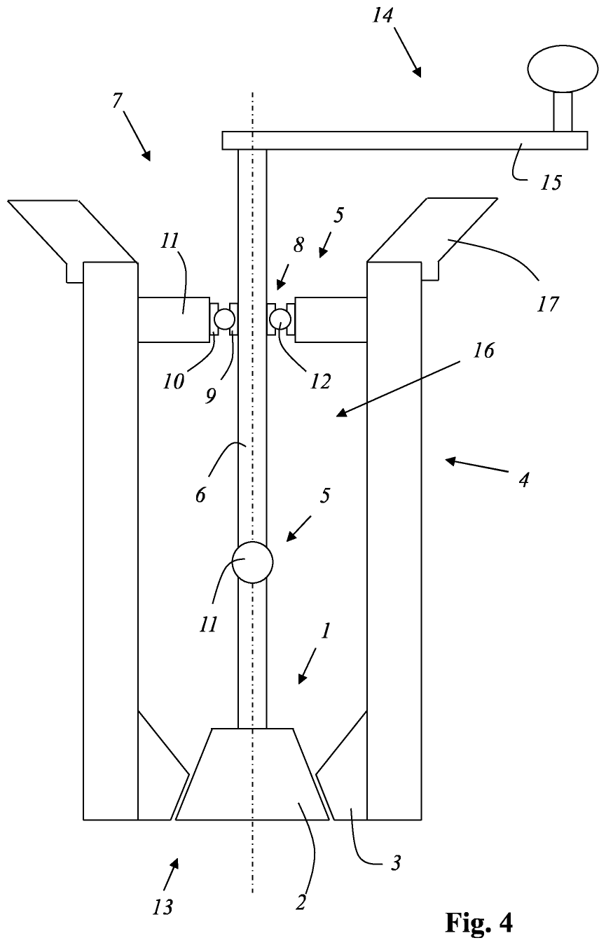

FIG. 4 shows a second exemplary embodiment of a spice grinder according to the disclosure in accordance with an independent inventive concept, the housing 4 of which, in contrast to the first exemplary embodiment, has an attachment that is manufactured separately, preferably from titanium or a titanium alloy, which acts as a filling funnel 17. It is also possible to produce the filling funnel 17 integrally from a single piece of raw material together with at least one other housing component, in particular together with a tubular housing portion.

### LIST OF REFERENCE SIGNS

grinding mechanism
grinding rotor
grinding stator
housing
bearing bracket
shaft
filling opening
rolling bearing
inner ring
outer ring
holding bar
rolling element
discharge opening
driving device
hand crank
receiving space
filling funnel

What is claimed is:

1. A coffee grinder having a grinding mechanism (1) and having a housing (4), which acts as a holder for at least one bearing bracket (5), by means of which at least one grinder element is mounted rotatably relative to the housing (4), and which has a filling opening (7) for coffee beans to be ground, wherein the housing (4) is manufactured from titanium or a titanium alloy.

2. The coffee grinder as claimed in claim 1, wherein the housing (4) is of tubular design wherein the filling opening (7) is formed by an upper tube opening.

3. (canceled)

4. The coffee grinder as claimed in claim 1, wherein the housing (4) has a discharge opening (13) for the coffee powder which is formed by a lower tube opening.

5. (canceled)

6. The coffee grinder as claimed in claim 1, wherein the housing (4) surrounds a receiving space (16) for coffee beans to be ground and wherein the at least one bearing bracket (5) is arranged in the receiving space (16) for coffee beans to be ground.

7. The coffee grinder as claimed in claim 1, wherein the housing (4) has a circular outer contour and/or a circular inner contour in a cross-sectional plane perpendicular to its direction of longitudinal extent.

8. The coffee grinder as claimed in claim 1, wherein the housing (4) is manufactured integrally from a single piece of raw material, in particular from a tube.

9. The coffee grinder as claimed in claim 1, wherein the housing (4) is of multipart design, wherein at least the part of the housing (4) on which the at least one bearing bracket (5) is directly arranged is manufactured integrally from a single piece of raw material, in particular from a tube.

10. The coffee grinder as claimed in claim 1, wherein the at least one bearing bracket (5) is secured on the inner side of the housing (4).

11. The coffee grinder as claimed in claim 1, wherein the at least one bearing bracket (5) is secured on the inner side of the housing (4) by frictional engagement and/or form-locking engagement.

12. The coffee grinder as claimed in claim 1, wherein the at least one bearing bracket (5) is secured without a materially bonded connection on the inner side of the housing

13. The coffee grinder as claimed in claim 1, wherein the at least one bearing bracket (5) is clamped between different portions of the inner side of the housing

14. The coffee grinder as claimed in claim 1, wherein the at least one bearing bracket (5) has at least one contact portion, which is shaped oppositely in complementary fashion to the portion of the housing (4) against which it rests.

15. The coffee grinder as claimed in claim 1, wherein the bearing bracket (5) is designed as a bar which is secured without a materially bonded connection on the inner side of the housing (4), wherein the ends of the bar are shaped oppositely in complementary fashion to the portions of the housing (4) against which they rest.

16. (canceled)

17. (canceled)

18. The coffee grinder as claimed in claim 1, wherein the at least one bearing bracket (5) can be mounted without tools in the housing and/or can be released without tools from the housing (4).

19. The coffee grinder as claimed in claim 1, wherein the at least one bearing bracket (5) is manufactured from titanium or a titanium alloy.

20. The coffee grinder as claimed in claim 1, wherein the coffee grinder has precisely two, in particular identical, bearing brackets (5) each bearing bracket (5) having a bearing, in particular a rolling bearing (8).

21. (canceled)

22. (canceled)

23. The coffee grinder as claimed in claim 1, wherein the grinder element is a shaft (6) which is connected for conjoint rotation to a driving device, on the one hand, and is connected for conjoint rotation to a grinding rotor (2), in particular to a grinding cone, of the grinding mechanism (1), on the other hand.

24. The coffee grinder as claimed in claim 23, wherein the grinder element is manufactured from titanium or a titanium alloy.

25. (canceled)

26. The coffee grinder as claimed in claim 23, wherein the driving device is designed as a hand crank (15) and wherein the housing (4) is designed to be held in one hand of a user during a grinding process, wherein the user can operate the hand crank (15) with their other hand.

27. (canceled)

28. (canceled)

29. The coffee grinder as claimed in claim 23, wherein the driving device is an electric drive motor.
